(19) United States
(12) Patent Application Publication
(10) Pub. No.: US 2006/0215517 A1
(43) Pub. Date: Sep. 28, 2006

(54) Determination of adaptive writing strategy for recording data onto optical information recording medium having full calibration area

(75) Inventors: Yung-Chih Hsu, Taoyuan (TW); Min-I Hung, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/388,489

(22) Filed: Mar. 24, 2006

(30) Foreign Application Priority Data
Mar. 25, 2005 (TW) 094109483

(51) Int. Cl. G11B 7/12

(52) U.S. Cl. 369/47.53

(57) ABSTRACT

The invention is to provide a method for determining an adaptive writing strategy and for controlling, according to the adaptive writing strategy, an optical information recording apparatus to record data onto an optical information recording medium. According to a preferred embodiment of the invention, first, a calibration area of the optical information recording medium is judged whether it is full or not. If the result of judgment is YES, at least one condition data associated with the optical information recording apparatus is accessed, and a plurality of OPC (optimum power calibration) data sets previously recorded on the optical information recording medium are retrieved. Then, based on the at least one condition data, one of the retrieved OPC data sets is selected. The adaptive writing strategy is determined in accordance with the selected OPC data set.

### FIELD OF THE INVENTION

The present invention relates to a method for determining an adaptive writing strategy and for controlling an optical information recording apparatus to record data onto an optical information recording medium in accordance with the adaptive writing strategy. More particularly, the calibration area of the optical information recording medium is full.

### DESCRIPTION OF THE PRIOR ART

Some of the optical information recording mediums, such as DVD-R disc or DVD+R disc, have a calibration area thereon for better recording quality. When recording data onto this kind of optical information recording medium, the optical information recording apparatus employs the calibration area to adjust the laser power of the optical pick-up unit; hence, the optimum power is determined, and the optimum writing strategy is then acquired.

However, there is limitation to the capacity of the above-mentioned calibration area. When an optical disc has been used to record data several times, the calibration area can easily be fully used, so the laser power cannot be adjusted through the calibration area; the optical information recording apparatus will then report an error message, so the optical disc cannot be used to record data anymore.

Accordingly, an objective of the present invention is to provide a method for determining an adaptive writing strategy, and an optical information recording apparatus is controlled to record data onto an optical information recording medium in accordance with the adaptive writing strategy.

### SUMMARY OF THE INVENTION

According to a preferred embodiment of the invention, first, a judging step is performed to judge if the calibration area is full. If the calibration area is full, at least one condition data associated with the optical information recording apparatus is accessed, and a plurality of OPC (Optimum power calibration) data sets are retrieved from the optical information recording medium. Finally, a first OPC data set is selected from the retrieved OPC data sets in accordance with the at least one condition data, and the adaptive writing strategy is determined in accordance with the selected first OPC data set.

The method for determining an adaptive writing strategy of the invention utilizes the successful calibration data stored in the optical information recording medium. When the calibration area is full, an adaptive writing strategy is determined dependably from previously stored calibration data. Therefore, users can use the adaptive writing strategy to record data onto the optical information recording medium.

The advantage and spirit of the invention may be understood by the following recitations together with the appended drawings.

### BRIEF DESCRIPTION OF THE APPENDED DRAWINGS

FIG. 1 is a flowchart illustrating the method for determining an adaptive writing strategy according to a preferred embodiment of the invention.

FIG. 2 is a flowchart illustrating the storage procedure of an OPC data set.

### DETAILED DESCRIPTION OF THE INVENTION

The objective of the invention is to provide a method for determining an adaptive writing strategy, and an optical information recording apparatus is controlled to record data onto an optical information recording medium in accordance with the adaptive writing strategy.

The optical information recording medium has a calibration area, and a first OPC (Optimum power calibration) data set is previously recorded in the optical information recording medium. The first OPC data set can employ the calibration result which was previously successful in the calibration area; the calibration result is determined by employing the optical pick-up unit of the optical information recording apparatus to perform the optimum power calibration procedure on the calibration area. The first OPC data set corresponds to a successful result of a previous calibration procedure, and it includes the successful result and the condition data associated with that previous calibration procedure.

In the method for determining an adaptive writing strategy, first, a first OPC data set is retrieved from the optical information recording medium. Afterwards, the adaptive writing strategy is determined in accordance with the first OPC data set, and according to the adaptive writing strategy, the optical information recording apparatus is controlled to record data onto the optical information recording medium.

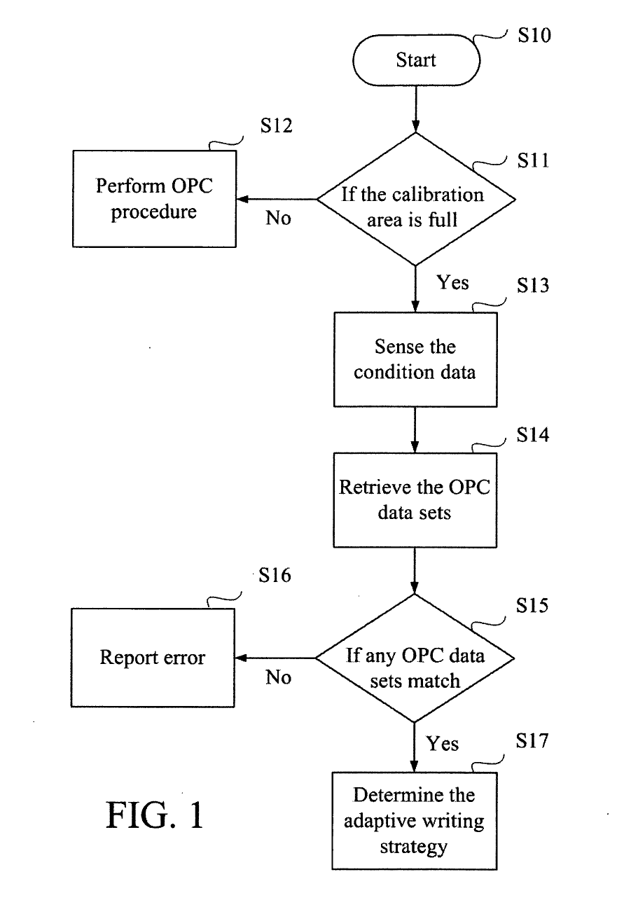

Referring to FIG. 1, FIG. 1 is a flowchart illustrating the method for determining an adaptive writing strategy according to a preferred embodiment of the invention.

In this preferred embodiment of the invention, an optical information recording medium has a calibration area and a plurality of previously recorded OPC data sets. The laser power of the optical pick-up unit of the optical information recording apparatus performs an optical power calibration procedure in the calibration area to obtain an optimum calibration result. The plurality of stored OPC data sets correspond to a plurality of previously successful calibration results obtained from the calibration area. Each of the first OPC data sets includes a successful result of a calibration procedure and the condition data associated with the calibration procedure. The plurality of stored OPC data sets together with a header are stored in the optical information recording medium, and the header is used to distinguish the format of the plurality of OPC data sets.

The objective of the method for determining an adaptive writing strategy is to determine an adaptive writing strategy, and an optical information recording apparatus is controlled to record data onto an optical information recording medium in accordance with the adaptive writing strategy. According to the method of the invention, an adaptive writing strategy can be determined easily and dependably.

As shown in FIG. 1, according to a preferred embodiment of the invention, the procedure for the method to determine an adaptive writing strategy has the following steps. First, performs step S10 to set the data such as initial conditions. Afterwards, step S11 is performed. In step S11, the calibration area is judged whether it is full or not. If the calibration area is not fully used, step S12 is performed. In step S12, an optimum power calibration is performed in the calibration area. If the calibration area is full, S13 and S14 are then performed. In step S13, at least one condition data associated with the optical information recording apparatus is accessed. In step S14, the plurality of OPC data sets are retrieved from the optical information recording medium. Finally, step S15 is performed to judge, based on the at least one condition data, whether the retrieved OPC data sets include any matching OPC data set. If NO in step S15, step S16 is performed to report an error on the calibration area. If YES in step S15, a first OPC data set is selected from the retrieved OPC data sets. Step S17 is then performed to determine the adaptive writing strategy in accordance with the selected first OPC data set. Finally, the optical information recording apparatus is controlled, according to the adaptive writing strategy, to record data onto the optical information recording medium.

In this preferred embodiment, the optical information recording medium has been used to record several times, and each of the OPC data sets corresponds to one of the many times in which the optical information recording medium is being used to record. Each of the OPC data sets includes at least one condition parameter and a writing strategy associated with that corresponding time of recording. The at least one condition parameter includes a parameter which is selected from a group consisting of at least one recording apparatus identity code, a writing speed, a recording temperature and other possible operating parameter of the optical information recording apparatus. The at least one condition data includes one piece of data which is selected from the group consisting of at least one identity code of the optical information recording apparatus, a temperature sensed in the optical information recording apparatus, a user-desired speed and other possible operating parameter of the optical information recording apparatus. The at least one identity code of the optical information recording apparatus includes at least one number which is selected from the group consisting of a code number of an OPU of the optical information recording apparatus, a serial number of the optical information recording apparatus and other possible identify number of the optical information recording apparatus.

Step S15 is performed to determine a plurality of OPC data sets of which the recording apparatus identity code matches the identity code of the optical information recording apparatus; furthermore, from the plurality of determined OPC data sets, at least one applicable set of OPC data sets are determined. From the at least one applicable set of OPC data sets, a first OPC data set is determined based on the temperature sensed in the optical information recording apparatus, the user-desired speed, and the writing speed and the recording temperature of that applicable set of OPC data sets.

In an embodiment, the optical information recording medium has been used to record a plurality of times, and each of the OPC data sets corresponds to one of the many times in which the optical information recording medium has been used to record. Each of the OPC data sets includes at least one recording apparatus identity code and a writing strategy associated with the corresponding time of recording. The at least one condition data includes at least one identity code of the optical information recording apparatus. The at least one identity code can be a code number of an OPU of the optical information recording apparatus; it can also be a serial number of the optical information recording apparatus.

Step S15 is performed to determine a plurality of OPC data sets of which the recording apparatus identity code matches the identity code of the optical information recording apparatus recording apparatus. Furthermore, from the plurality of determined OPC data sets, a first OPC data set is determined.

In an embodiment, the plurality of OPC data sets are stored in at least one disc block of the optical information recording medium.

In an embodiment, the optical information recording medium is a DVD+R disc. The at least one disc block includes a reserved block of a Session Disc Control Block (SDCB) and a Table of Contents (TOC) block.

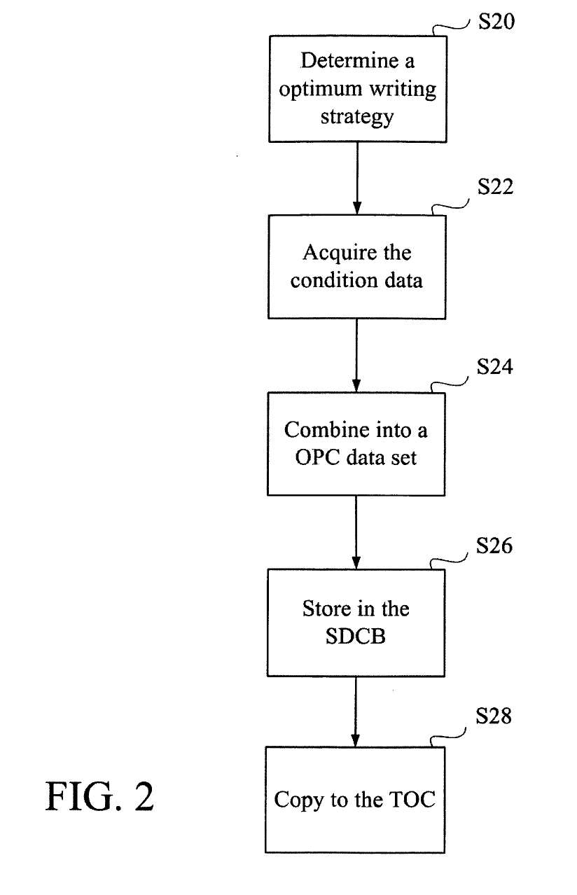

Referring to FIG. 2, FIG. 2 is a flowchart illustrating the procedure for retrieving and storing an OPC data set in a DVD+R disc. First, step S20 is performed in which an optical information recording apparatus, for that corresponding time of recording, is controlled to record at least one test data onto the calibration area using various writing strategies; then, an optimum writing strategy associated with that corresponding time of recording is determined. Step S22 is then performed to acquire at least one condition data associated with that corresponding time of recording, and the acquired at least one condition data is set as the at least one condition parameter. Step S24 is then performed in which the optimum writing strategy of the corresponding time of recording and the at least one condition parameter of the corresponding time of recording are combined into the OPC data set. In step S26, the OPC data set is updated into the reserved block of the SDCB when closing track or reversing track. When the optical information recording medium closes session, step S28 is performed to copy the OPC data set from the SDCB into the TOC. Therefore, the optical information recording apparatus can retrace the OPC data set from the reserved block of the SDCB or the TOC.

In an embodiment, the optical information recording medium is a DVD-R disc, and the at least one disc block includes a reserved block of Recording Management Data (RMD) in the Recording Management Area (RMA).

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for determining an adaptive writing strategy and controlling an optical information recording apparatus to record data onto an optical information recording medium in accordance with the adaptive writing strategy, said method comprising the steps of:
(a) retrieving a first OPC (Optimum power calibration) data set from the optical information recording medium;
(b) according to the first OPC data set, determining the adaptive writing strategy; and
(c) according to the adaptive writing strategy, controlling the optical information recording apparatus to record data onto the optical information recording medium.

2. The method of claim 1, wherein step (a) is performed by the steps of:
(a1) retrieving a plurality of OPC data sets comprising the first OPC data set from the optical information recording medium;
(a2) accessing at least one condition data associated with the optical information recording apparatus; and
(a3) based on the accessed at least one condition data, selecting one from the retrieved OPC data sets as the first OPC data set.

3. The method of claim 2, wherein the optical information recording medium has a calibration area, and the calibration area is full.

4. The method of claim 2, wherein the plurality of OPC data sets together with a header are stored in the optical information recording medium, and the header is used to distinguish the format of the plurality of OPC data sets.

5. The method of claim 2, wherein the optical information recording medium has been used to record a plurality of times, and each of the OPC data sets corresponds to one of the times of recording.

6. The method of claim 5, wherein each of the OPC data sets comprises at least one condition parameter associated with that corresponding time of recording and a writing strategy associated with that corresponding time of recording, the selection of the first OPC data set in step (a3) is performed by the step of:
from the plurality of OPC data sets, selecting the OPC data set, of which at least one condition parameter matches the at least one condition data, as the first OPC data set.

7. The method of claim 6, wherein the at least one condition parameter comprises one parameter selected from the group consisting of at least one recording apparatus identity code, a writing speed and a recording temperature, the at least one condition data comprises one piece of data selected from the group consisting of at least one identity code of the optical information recording apparatus, a temperature sensed in the optical information recording apparatus, and a user-desired speed.

8. The method of claim 7, wherein the optical information recording apparatus comprises an OPU (Optical pick-up unit), and the at least one identity code of the optical information recording apparatus comprises one number selected from the group consisting of a code number of the OPU and a serial number of the optical information recording apparatus.

9. The method of claim 2, wherein the plurality of OPC data sets are stored in at least one disc block of the optical information recording medium.

10. The method of claim 9, wherein the at least one disc block is outside a calibration area of the optical information recording medium.

11. The method of claim 9, wherein the optical information recording medium is a DVD+R disc, and the at least one disc block comprises a reserved block of the Session Disc Control Block (SDCB) and a Table of Contents (TOC) block.

12. The method of claim 9, wherein the optical information recording medium is a DVD-R disc, and the at least one disc block comprises a reserved block of Recording Management Data (RMD) in the Recording Management Area (RMA).

13. The method of claim 5, wherein each of the plurality of OPC data sets is acquired at the corresponding time of recording by the steps of:
performing an optical power calibration procedure, and determining an optimum writing strategy associated with the corresponding time of recording;
acquiring at least one condition data associated with the corresponding time of recording, and setting the acquired at least one condition data as the at least one condition parameter; and
combining the optimum writing strategy with the at least one condition parameter into the OPC data set, and recording the OPC data set in a predetermined position of the optical information recording medium.

14. The method of claim 13, wherein the optical power calibration procedure is performed for the corresponding time of recording to control the optical information recording apparatus to record at least one test data onto the calibration area using various writing strategies and to further determine the optimum writing strategy associated with the corresponding time of recording.
